(19) United States
(12) Patent Application Publication
(10) Pub. No.: US 2018/0058636 A1
(43) Pub. Date: Mar. 1, 2018

(54) SCREW-FREE MODULAR DESIGN LIGHTING FIXTURE INVENTION WITH INTERCHANGEABLE PARTS

(71) Applicant: XIAMEN HOLLY LITE CO., LTD., Xiamen (CN)

(72) Inventors: Yiwei WANG, Xiamen (CN); Hongyan WANG, Xiamen (CN); Shifu CHEN, Xiamen (CN)

(73) Assignee: XIAMEN HOLLY LITE CO., LTD., Xiamen (CN)

(21) Appl. No.: 15/685,791

(22) Filed: Aug. 24, 2017

(30) Foreign Application Priority Data
Aug. 24, 2016 (CN) 201610712747.9

(51) Int. Cl. F21K 9/272; F21V 17/02; F21K 9/275; F21V 17/10; F21K 9/278; F21V 17/00

(52) U.S. Cl. CPC F21K 9/272; F21V 17/02; F21V 17/002; F21V 17/10; F21K 9/278; F21K 9/275

(57) ABSTRACT

A screw-free modular design lighting fixture with interchangeable parts includes a lens cover, a round cover, a PCB, and the heat sink that make up the module, as well as a driver, a fastener on the driver, a frame, and a push release mechanism to secure the driver onto the module, then the module onto the frame to form the fixture. The lighting fixture uses push-release, clip on, twist on, click in, slide in, hinge-on, and other screw-free mechanisms to assemble, interchange, and maintain the module, frame, and drivers, in order to change the applications, light distributions, wattages, voltage, and other needs of the fixture.

### FIELD OF THE INVENTION

The present invention takes a step into the technological front of the lighting industry especially by eliminating the use of screws to combine the various parts of the fixture. The present invention enables the users to interchange various parts of the fixtures such as the lens cover, PCB, driver, the heatsink, and the frame to assemble fixtures such as street light, flood light, wall pack, high bay, canopy, tunnel light, and for different applications.

### BACKGROUND OF THE INVENTION

Lighting products are often seen as consumables. As technology advances from fluorescent lamps and energy saving lamps to the invention of light emitting diode (LED), lighting industry has experienced major changes. The industry has become more innovative, energy efficient, and environmentally friendly ever since the development in lighting choices. As infrastructures such as parks, hospitals, estates, institutions, roads, and offices rise, the requirement for more diversified lighting fixtures also rises.

### DESCRIPTION OF THE RELATED ART

According to China's Patent Announcement of CN202209633U, the structure and the application of the lighting fixtures in the market so far are fixed. This means that the lens is fixed to the LED chips and cannot be reassembled by the user. Manufactures must make multiple molds for numerous fixtures since the structure and housing will differ according to various lighting distributions, applications, and light engines. This not only increases the mold cost, production cost, and maintenance cost of the fixtures, but also prohibits mass production and reduces the economies of scale. Due to the complexity of the fixtures, most of the parts within the fixture need additional tools to assemble and maintain, thus increasing the cost for the users as well.

### SUMMARY OF THE INVENTION

Xiamen Holly Lite has overcame the obstacles to invent the screw-free modular design lighting fixture invention with interchangeable parts so that the user can interchange the lens, module, driver, and the heat sink in combination with the frame to make different lighting luminaires for various applications. This invention features fast, easy, and screw free assembly and maintenance, freedom of interchange parts, multiple combinations of modules, and lower production cost.

This screw-free modular design lighting fixture invention enables the user to interchange the following parts:

A series of frames with dugouts for the Module Fastener on each frame. This dugout is to be joined with the Module Fastener to form a combined part in order to secure the module onto the frame by inserting the connection tab onto the Module Fastener. Different frames in combination with various modules can be formed into fixtures including but not limited to street light, floodlight, wall pack, highbay, canopy, and tunnel light.

The Module Fastener includes the push button, the buckle, the slider, the spring, the bounce plate, and the bottom plate. The heatsink can be attached to the frame by inserting the tab into the Module Fastener. To release, press the push button to remove the heatsink from the module.

The interchangeable lens covers have one or more types of prearranged individual lenses already attached for different light distribution types. The shape of the lens cover can be changed according to the needs of the end users such as circular, rectangular, triangular, trapezoidal, oval, etc.

A round cover: The round cover secures the lens cover and the PCB onto the heatsink by pushing the twist knobs on the four corners of the round cover to rotate and tighten with the grooves and grip tabs on the inner circle.

A driver: the driver will be compatible based on the wattage of the module.

A driver fastener: this fastener includes the main body, moveable chutes, and springs.

When the chutes are squeezed, the spring retracts to assemble or disassemble the driver

A Printed Circuit Board (PCB): The PCB is an aluminum board with prearranged LED chips already attached

A heatsink: the heatsink has connections available to combine with other heatsinks as well as the connection tab to attach to various frames for different application and lighting needs

The round cover secures the lens cover along with the PCB when it is fitted into the PCB slot on top of the heatsink. All of the lens covers mentioned above can be secured by rotating the round cover. The twist knobs on the round cover are designed to make the rotating motion easier. The combination of the lens cover and PCB on top of the heatsink secured by the round cover makes the basis of the module. This interchangeable structural design enables the user to choose and exchange the lens cover to make different modules for various lighting distribution and application needs.

The module is then secured onto the frame by inserting the connection tabs into the Module Fastener and released when the push button is pressed.

The module, lens cover, driver, and frame are assembled according to but not limited to the following mechanisms: click-in, twist-on, slide-in, push-release, clip-on, and hinge-on.

The heatsink can also be joined together to satisfy various lighting applications or when additional heat dissipation is needed. The module and the frame can be joined with their respective male and female part for screw-free assembly.

The driver is independent of the module, but compatible with the wattage of the module. Depending on various lighting applications, the driver is interchangeable with screw free assembly for easy installation and maintenance.

Compared to existing fixtures and modules, the ingenuity of this invention is in:

1. This invention uses a frame, a module fastener, a lens cover, a round cover, a driver, a driver fastener, a PCB, and a heatsink to provide a screw-free way to interchange the parts of the fixture. The surface of the heatsink has the PCB slot for the PCB to fit into. Then the lens cover sits on top of the PCB and secured by the round cover to make the basis of the module. The lens cover can be interchanged quickly with different sets of prearranged individual lenses already attached to the cover for various lighting distribution and application needs.

2. Because of this structure, the user can interchange and combine the modules, lens covers, drivers, and frames for different applications such as street light, flood light, wall pack, highbay, canopy, tunnel light, etc. Since there is a set number of modules and frames to apply to this technology, it reduces the need for multiple molds of traditional non-interchangeable fixtures, thus decreasing the cost of materials and increasing the economies of scale.

3. The module, lens cover, driver, and frame are assembled according to but not limited to the following mechanisms: click-in, twist-on, slide-in, push-release, clip-on, and hinge-on. These methods are not only fast and easy for assembly and maintenance, but the screw-free feature also enables the users to assemble the fixture without the needs of any additional tools.

The figures and examples below explain the invention in detail. However, the screw-free modular design lighting fixture invention includes but does not limit to the following examples.

### BRIEF DESCRIPTION OF THE DRAWINGS

FIG. 1 names each part of the fixture in Embodiment 1;

FIG. 2 shows in detail of the module fastener in Embodiment 1;

FIG. 3 explains the parts of the round cover used to secure the lens in Embodiment 1;

FIG. 4 shows the detail of the driver fastener in Embodiment 1;

FIG. 5 explains the structure of the fixture for Embodiment 2;

FIG. 6 shows the knockouts available for photocell and motion sensor in Embodiment 2;

FIG. 7 explains the structure shown in Embodiment 3;

FIG. 8 shows the rectangular shape lens module shown in Embodiment 4;

FIG. 9 shows the triangular shape lens module shown in Embodiment 5;

FIG. 10 shows the diamond shape lens module shown in Embodiment 6;

FIG. 11 shows the trapezoid shape lens module shown in Embodiment 7;

FIG. 12 shows the oval shape lens module shown in Embodiment 8;

### DETAILED DESCRIPTION OF THE EMBODIMENTS

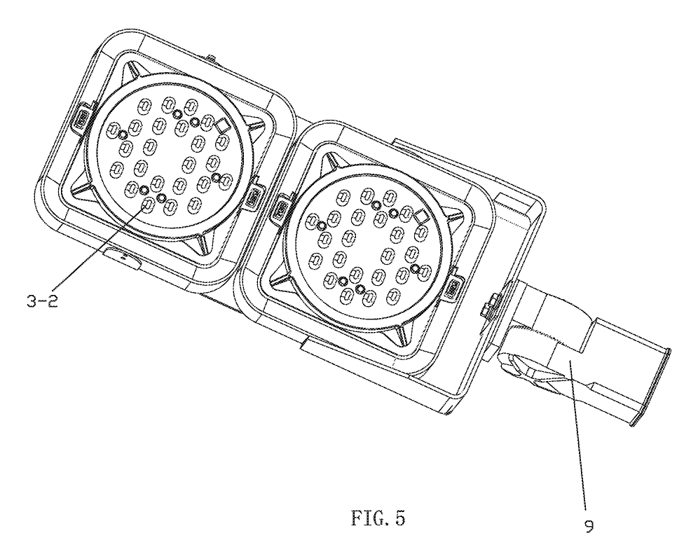

### Embodiment 1 (FIG. 5)

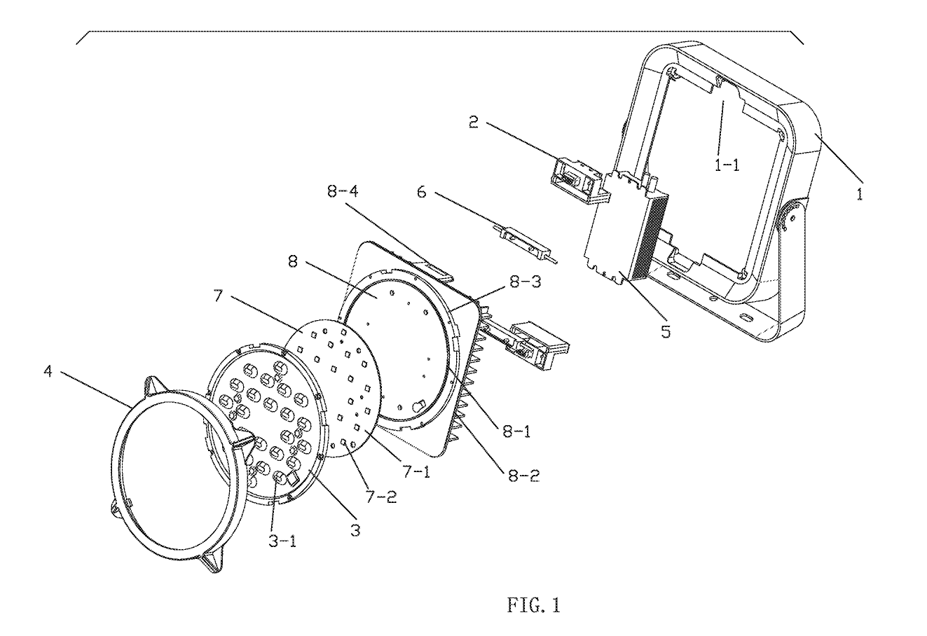

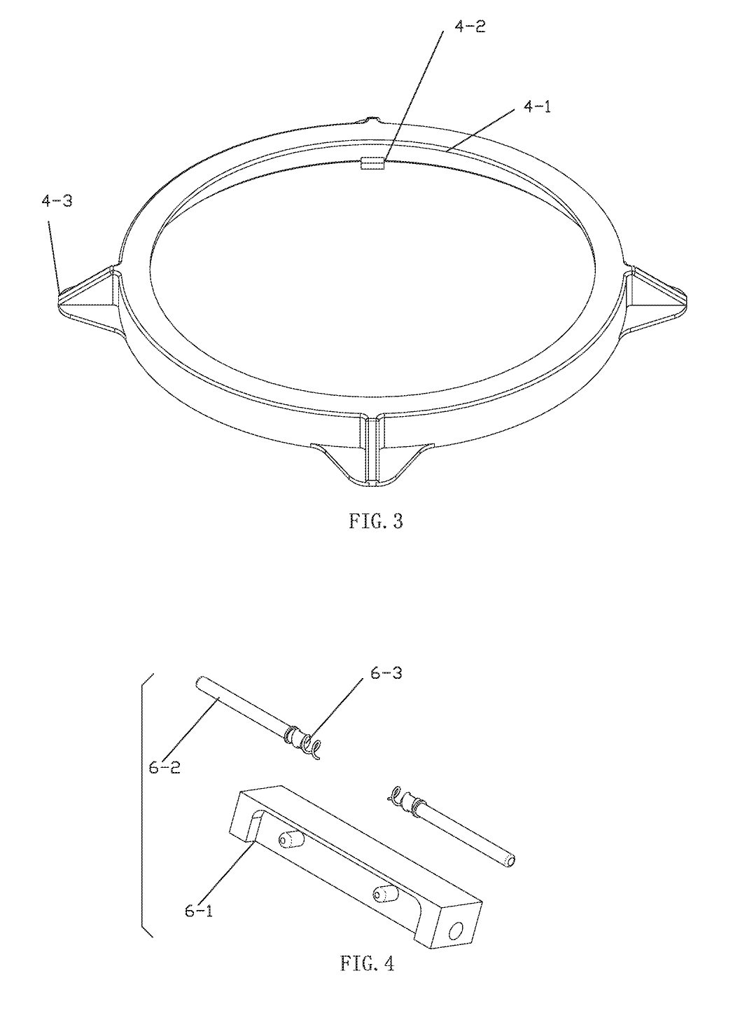

With reference to FIGS. 1 to 4, this is a screw-free modular design lighting fixture invention. Embodiment 1 is based on the single flood light module version of the series.

The module fastener dugout 1-1 on the frame 1 allows the Module Fastener 2 to join together to form one part in order for the module to attach to the frame 1.

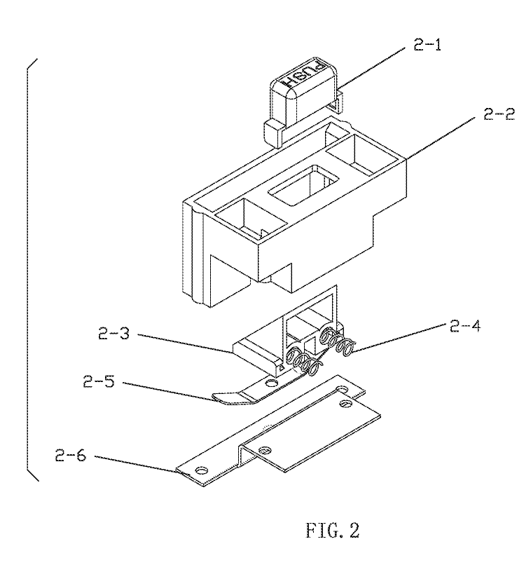

Module fastener 2 as shown in FIG. 1 is further broken down in FIG. 2 including the push button 2-1, the buckle 2-2, the slider 2-3, the spring 2-4, the bounce plate 2-5, and the bottom plate 2-6. When the connection tabs 8-4 on the heatsink 8 is inserted into the buckle opening 2-2, the slider 2-3 moves out to allow the insertion and slides back into place with the help of the springs 2-4 to secure the connection tab 8-4. When the push button 2-1 is pressed, slider 2-3 slides out once again and pushes down the bounce plate 2-5 with the help of the springs 2-4 to release the connection tab 8-4 and removes the module from the fastener.

Depending on different requirements and preferences, the user can choose different lens covers 3 with prearranged individual lenses 3-1 already attached.

The round cover 4 has grooves 4-1 and grip tabs 4-2 along the inner circle of the round cover to twist the round cover onto the heatsink 8 along the heatsink grooves 8-3 to secure the lens cover 3 along with the PCB 7 onto the heatsink 8. This rotating motion is facilitated by the twist knobs 4-3 located on the outer perimeter of the round cover 4.

Each module furnishes with a compatible driver 5 according to the wattage and voltage of the module.

The driver fastener 6 includes the main body 6-1, movable chutes 6-2, and springs 6-3. When the chutes 6-2 are squeezed, the springs 6-3 contract to release the driver.

The Printed Circuit Board (PCB) 7 includes the aluminum board 7-1 with prearranged LED chips 7-2 already attached to the aluminum board.

The heatsink 8 includes the PCB slot 8-1, the heatsink connectors 8-2, the heatsink grooves 8-3 to secure with the round cover 4, and the connection tabs 8-4. The heatsink 8 is interchangeable with regards to the frames 1 depending on the wattage and the application of the fixture.

The Lens Cover 3 is interchangeable, and secured by the round cover 4. The PCB 7 with LED chips 7-2 already attached is to be placed in the PCB slot 8-1 located on the surface of the heatsink 8. Then, the interchangeable Lens Cover 3 is placed on top of the PCB 7 and secured by the round cover 4 by rotating the round cover using the twist knobs 4-3. The combination of the Lens Cover 3 and PCB 7 secured by the round cover 4 along with the heatsink 8 makes up the basis of the module. Different lens covers 3 are used to make various lighting distributions and applications needs.

The Module Fastener 2 is secured onto the dugout for the module fastener 1-1 on frame 1 so that the module can be assembled onto the frame 1 by inserting the connection tabs 8-4 into the buckle 2-2 and released by pressing the push button 2-1 to release.

The heatsink 8, lens cover 3, driver 5, and frame 1 are assembled according to but not limited to the following mechanisms: click-in, twist-on, slide-in, push-release, clip-on, and hinge-on.

The heatsink 8 can be connected with other heatsinks 8 with the frame 1 by using connection tabs 8-4 and the Module Fastener 2. This screw free assembly method makes installation and maintenance fast and easy.

The driver is independent of the module, but compatible with the wattage of the module. Depending on various lighting applications, the driver is interchangeable with screw free assembly for easy installation and maintenance.

The screw-free modular design lighting fixture invention with interchangeable parts has lens covers 3 with individual lenses 3-1 already attached for various lighting distribution and application needs. The lens covers 3 are secured by the round cover 4 and interchangeable for fast and easy assembly and maintenance.

Through this invention, the users can interchange modules, lens covers, drivers, frames, and PCB's at their fingertips for various lighting distributions and application needs. The fixtures produced by this invention can be used including but not limited to street light, flood light, wall pack, highbay, canopy, and tunnel light.

This invention reduces the need for multiple molds of traditional non-interchangeable fixtures, thus decreasing the cost of materials and increasing the economies of scale.

The module, lens cover, driver, and frame are assembled according to but not limited to the following mechanisms: click-in, twist-on, slide-in, push-release, clip-on, and hinge-on. These screw-free assembly methods make installation and maintenance fast and easy.

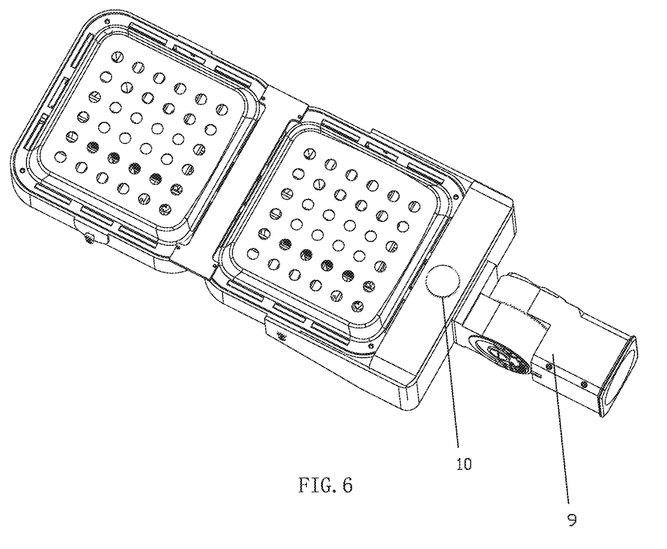

### Embodiment 2 (FIG. 6)

As FIGS. 5 and 6 show, this is a screw-free modular design lighting fixture invention with interchangeable parts. This Embodiment shows the street light application.

The street light includes two modules with the double street light frame. The lens cover 3 uses the prearranged individual lenses 3-2 best for the street light application. There are multiple lens covers available with different prearranged individual lenses 3-2 according to various lighting distribution and application needs including but not limited to the type shown in this Embodiment. The lens cover 3 with prearrange individual lenses 3-2 is interchangeable and secured by the round cover 4 with the heatsink 8 for fast and easy assembly. In this Embodiment, the two modules joined together to form one fixture by combining the connection tabs 8-4 located on the heatsink 8 with the module fastener 2 located on the frame 1 according to the wattage and application of the fixture.

Furthermore, FIG. 6 also has a smart control knockout 10 available for smart control applications such as photocell, motion sensor, wifi connectivity, and other usages. FIG. 6 shows the smart control knockout located on the housing of the fixture.

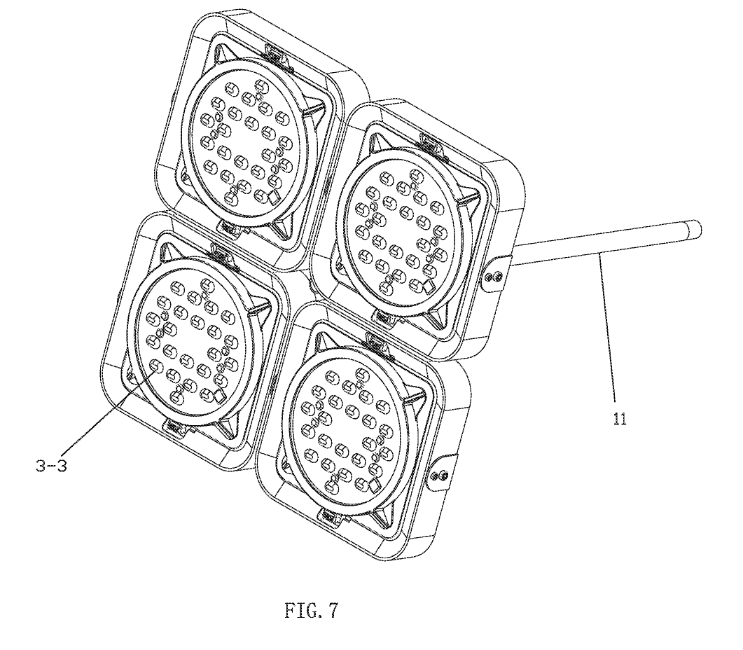

### Embodiment 3 (FIG. 7)

FIG. 7 shows a highbay Embodiment of the screw-free modular design lighting fixture invention with interchangeable parts.

The highbay fixture includes four modules along with the highbay frame 11. The lens cover) now uses prearranged individual lenses 3-3 best for highbay applications.

The prearranged individual lenses 3-2 can be changed according to various lighting distribution and application needs including but not limited to the type shown in this embodiment. The lens cover 3 with prearrange individual lenses 3-3 according to highbay application is interchangeable and secured by the round cover 4 with the heatsink 8 for fast and easy assembly. In this embodiment, the four modules joined together to form one fixture by using the heatsink connectors 8-2 located on the heatsink 8 depending on the wattage and application of the fixture.

### Embodiment 4 (FIG. 8)

As shown in FIG. 8, this is a screw-free modular design lighting fixture invention with interchangeable parts. FIG. 8 shows the lens cover 3 being a rectangle 3-4. Since the lens cover is a rectangle, the PCB slot 8-1 should also be rectangular.

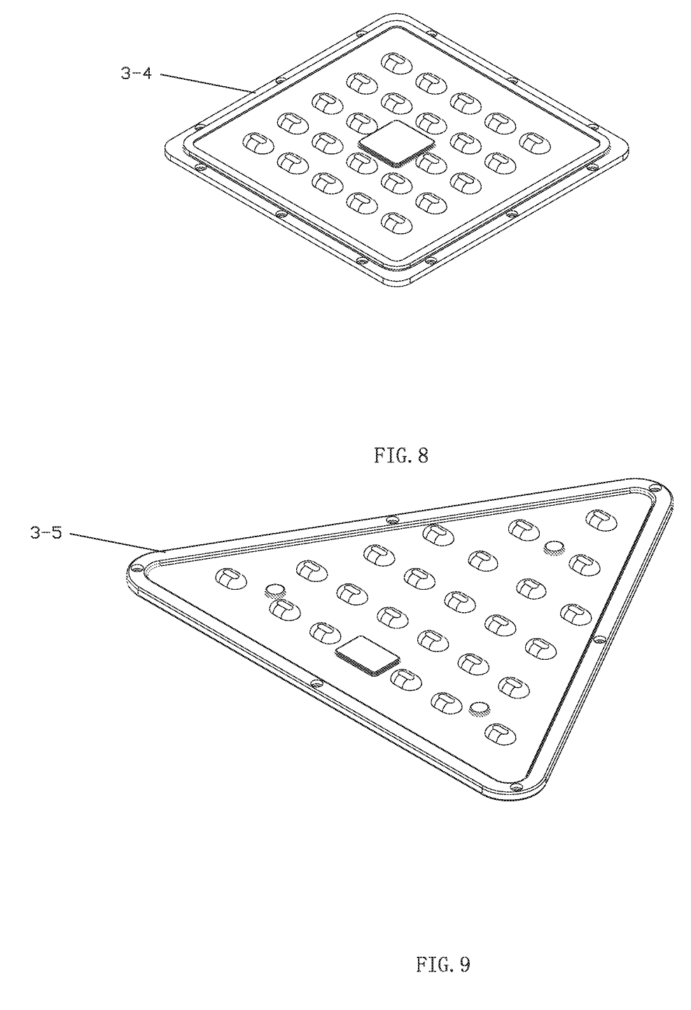

### Embodiment 5 (FIG. 9)

As shown in FIG. 9, this is a screw-free modular design lighting fixture invention with interchangeable parts. This Embodiment shows the lens cover 3 being a triangle 3-5. Since the lens cover is a triangle, the PCB slot 8-1 should also be triangular.

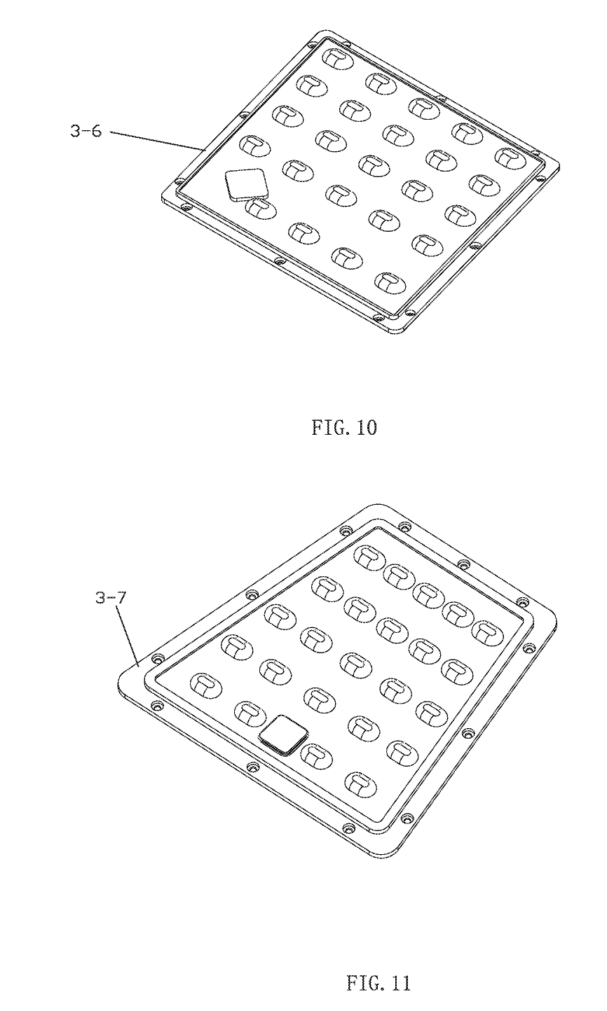

### Embodiment 6 (FIG. 10)

As shown in FIG. 10, this is a screw-free modular design lighting fixture invention with interchangeable parts. This Embodiment shows the lens cover 3 being a diamond 3-6. Since the lens cover is a diamond, the PCB slot 8-1 should also be diamond.

### Embodiment 7 (FIG. 11)

As shown in FIG. 7, this is a screw-free modular design lighting fixture invention with interchangeable parts. This Embodiment shows the lens cover 3 being a trapezoid 3-4. Since the lens cover is a trapezoid, the PCB slot 8-1 should also be trapezoidal.

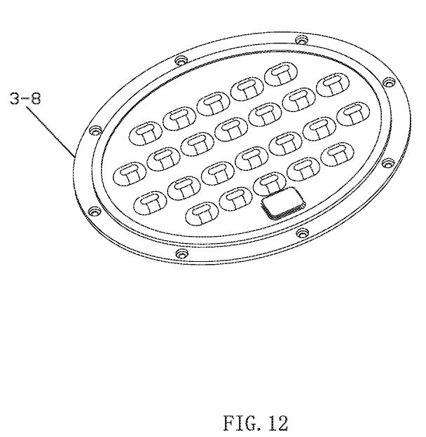

### Embodiment 8 (FIG. 12)

As shown in FIG. 12, this is a screw-free modular design lighting fixture invention with interchangeable parts. This embodiment shows the lens cover 3 being an oval 3-8. Since the lens cover is an oval, the PCB slot 8-1 should also be oval.

In FIG. 6, the fixture does not have the smart control installed. However, smart control can be installed in all fixtures such as photocell, motion sensor, wifi connection, and other smart control capabilities.

The manner of usage and operation of the present invention should be apparent from the above description. Accordingly, no further discussion relating to the manner of usage and operation will be provided. Changes may be made in detail, especially in matters of shape, size, screw-free assembly mechanism, lighting application, material, wattage, and arrangement of parts within the principles of the invention to the full extent indicated by the broad general meaning of the terms in which the appended claims are expressed. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A screw-free modular design lighting fixture with interchangeable parts, wherein comprising:
An outer frame, comprising:
a dugout for the Push-release buckle to combine the module with the frame using the connection tab to insert into the Push-release buckle;
A Module Fastener, comprising:
A push-release buckle like Mechanism with:
a push button;
a buckle;
a slider;
two springs;
at least one bounce plate;
and bottom plate;
A customizable lens cover, comprising:
At least one interchangeable lens cover for each module with:
prearranged individual lenses already attached for various light distribution types;
A round cover, comprising:
Twist knobs on the outer perimeter of the round cover to enable the twist-on motion;
Grooves imprinted on the inner circle of the round cover to enable the cover to be twisted onto a heatsink;
Grip tabs imprinted along the grooves of the inner circle of the round cover to tighten the round cover onto the heatsink to secure the lens cover and PCB board;
A driver: each module has a compatible driver;
A driver fastener, comprising:
The main body;
Movable chutes to attach and release the driver from the module;
Springs to make the chutes movable;
Printed Circuit Board (PCB), comprising:
An aluminum board;
At least one prearranged LED chip combined with the aluminum board;
A heatsink, comprising:
PCB Slot for the PCB to fit onto the heatsink;
Heatsink grooves along the outer perimeter of the PCB slot for the round cover to twist onto;
Heatsink fins located on the back of the heatsink for heat dissipation;
Connecting tabs on the sides of the heatsink for the module to attach onto the frame;
all of the interchangeable lens covers can be combined with the PCB in the PCB slot on the surface of the heatsink; the user can select any of the lens covers in combination with the PCB, align the two onto the PCB Slot on the heatsink, and twist on the round cover to form the basis of the module; the user can choose lens covers with different light distributions for various lighting applications, design needs, and fixture types; the lens covers are interchangeable using screw-free mechanisms including but not limited to twist-on, clip-on, slide-in, and hinge-on.

2. The screw-free modular design lighting fixture invention with interchangeable parts as claimed in claim 1, wherein the module secures onto the frame by inserting the connection tab of the module onto the push-release buckle on the frame to assemble the fixture.

3. The screw-free modular design lighting fixture invention with interchangeable parts as claimed in claim 1, wherein the fixture includes the twist-on feature of the round cover to secure the lens cover and PCB onto the heatsink.

4. The screw-free modular design lighting fixture invention with interchangeable parts as claimed in claim 1, wherein the module, lens cover, driver, and cover use screw-free assembly methods to assemble and disassemble; the interchangeable ability of the modules using mechanisms including but not limited to click-in, slide-in, clip-on, twist-on, and hinge-on.

5. The screw-free modular design lighting fixture invention with interchangeable parts as claimed in claim 1, wherein the heatsink connectors can be combined with the outer frames to form multiple fixtures; the module and the frame use male (connection tab) and female (Module Fastener) mechanisms to combine the two parts into a functional fixture to eliminate the use of screws.

6. The screw-free modular design lighting fixture invention with interchangeable parts as claimed in claim 1, wherein the interchangeable driver can be used independently for fast and easy installation, maintenance, and interchange.

7. The screw-free modular design lighting fixture invention with interchangeable parts as claimed in claim 5, wherein heatsink fins are configured at the bottom of the heatsink for heat dissipation.

8. The screw-free modular design lighting fixture invention with interchangeable parts as claimed in claim 2, wherein the module, lens cover, driver, and cover use screw-free assembly methods to assemble and disassemble; the interchangeable ability of the modules using mechanisms including but not limited to click-in, slide-in, clip-on, twist-on, and hinge-on.

9. The screw-free modular design lighting fixture invention with interchangeable parts as claimed in claim 3, wherein the module, lens cover, driver, and cover use screw-free assembly methods to assemble and disassemble; the interchangeable ability of the modules using mechanisms including but not limited to click-in, slide-in, clip-on, twist-on, and hinge-on.
